(19) United States
(12) Patent Application Publication
(10) Pub. No.: US 2002/0071784 A1
(43) Pub. Date: Jun. 13, 2002

(54) Dry analytical element and it's manufacturing method

(75) Inventors: Kazuya Kawasaki, Saitama (JP); Yoshikazu Amano, Saitama (JP)

Correspondence Address: Jules E. Goldberg, Esq., Reed Smith LLP, 375 Park Avenue, New York, NY, 10152, US

(73) Assignee: Fuji Photo Film Co., Ltd.

(21) Appl. No.: 09/978,142

(22) Filed: Oct. 15, 2001

(30) Foreign Application Priority Data
Oct. 16, 2000 (JP) 314756/2000

(51) Int. Cl. G01N 31/22

(52) U.S. Cl. 422/56; 436/169

(57) ABSTRACT

A dry analytical element free from unevenness of concentration of a reagent supplied by coating on a spreading layer made of a polyester fabric or unevenness of coloring density is provided. Said dry analytical element consists of at least one water-permeable layer and a spreading layer made of polyester having a function of spreading liquid uniformly laminated on a water-impermeable transparent support in this order, characterized in that the surface of fiber composing the polyester spreading layer is coated with an organic solvent.

### FIELD OF THE INVENTION

This invention is directed to a dry analytical element to analyze material existing in a liquid sample and method of manufacturing the element.

### BACKGROUND OF THE INVENTION

A dry analytical element is particularly useful in the field of clinical diagnosis in which a prompt and highly precise result is required to determine quantitatively an analyte contained in such biological samples as blood, spinal fluid, urine, extracts from feces, and the like.

An integral multilayer analytical element has been developed as an implement which enables a precise quantitative analysis of a liquid sample in a small quantities. Now various studies are conducted to improve or diversify the element. The dry analytical element contains the all reagents necessary to analyze a target analyte in advance. Using the dry analytical element, quantitative analysis is made possible only by the measurement of color development caused by spotting a liquid sample on the element.

The dry analytical element has a fundamental layer structure comprising a water-permeable layer and a porous spreading layer laminated on a water-impermeable transparent support in this order.

The porous spreading layer has a function to spread components included in an aqueous liquid sample in plane with substantially even distribution and to supply them to the water-permeable layer at a constant rate per an unit area. By now various kinds of spreading layer are developed for the dry analytical element. Examples of the spreading layer include nonfibrous isotropic microporous medium layers represented by membrane filter (blushed polymer) disclosed in U.S. Pat. No. 3,992,158, nonfibrous porous layers represented by continuous space-containing three dimensional lattice grain structure layer where polymer particulates are joined in point contact by a water-nonswelling adhesive disclosed in U.S. Pat. No. 4,258,001, porous layers composed of woven fabric disclosed in U.S. Pat. No. 4,292,272, GB 2,087,074A etc., porous layers composed of knitted fabric disclosed in EP 0,162,302A, and the like.

As concrete examples, following layers can be mentioned: microporous membrane of cellulose derivatives (DAC, TAC, NC, HMC(hydroxymethyl cellulose) or HEC(hydroxyethyl cellulose); microporous membrane made of ethylene polymers or copolymers, such as polyethylene, polypropylene, vinyl chloride etc.; microporous membrane made of polyethylene terephthalate, polycarbonate or polysulfone etc.; microporous membrane made of vinyl polymers or copolymers of acrylic acid, methacrylic acid or their esters; microporous membrane made of condensation polymers such as nylons, polyamide, or polyurethane etc.; microporous membrane fabricated by combining fine particles of inorganic material, such as glass or diatomite with a small quantity of polymer; microporous membrane made of polytetrafluoroethylene; paper filter or glass fiber filter.

Each microporous membrane mentioned above has good and bad points, and so various kinds of membrane are employed. Among them there is polyester fabric. However, polyester fabric can not be employed as it is, since polyester is hydrophobic, and so it is treated to contain a surfactant or a hydrophilic polymer to accelerate spreading of an analyte.

However, a dry analytical element with thus treated polyester fabric sometimes resulted in unevenness in color development of the reagent.

### SUMMARY OF THE INVENTION

The present inventors eagerly examined to resolve the problem and discovered that a hydrophilic polymer or a reagent was not contained uniformly in polyester fabric caused by uneven soakage of a coating solution during manufacturing process of a dry analytical element.

Then, the present inventors have examined various means to make polyester fabric hydrophilic beforehand, and have discovered that the problem above mentioned can be resolved by coating an organic solvent on a spreading layer included in a laminate composed of a support, a water-permeable layer and a spreading layer made of polyester fabric to make the spreading layer hydrophilic prior to coating of a reagent solution.

Thus, this invention relates to a dry analytical element comprising a water-impermeable transparent support, a water-permeable layer consisting of at least one layer laminated on the support, and further a spreading layer made of polyester fabric which is laminated on the water-permeable layer and have a function to spread liquid uniformly, characterized in that the surface of the fiber composing the polyester spreading layer is covered with an organic solvent; and to a manufacturing method of a dry analytical element comprising a step of supplying an organic solvent on a spreading layer which is made of polyester fabric, has a function to spread liquid uniformly, and is laminated on a water-permeable layer consisting of at least one layer laminated on a water-impermeable transparent support, and a subsequent step of supplying a reagent solution on the spreading layer.

### DESCRIPTION OF THE PREFERRED EMBODIMENT

The fundamental construction of the dry analytical element in accordance with the present invention is a build-up of layers comprising a water-permeable layer and a porous spreading layer laminated on a water-impermeable transparent support in this order.

The present invention is characterized in that the porous spreading layer is made of a polyester fabric, and that an organic solvent is supplied on the porous spreading layer prior to supplying a reagent solution.

The polyester includes polyethylene terephthalate, polyethylene naphthalate etc. The polyester fabric may be either knitted or woven and is in a range of about 50 to 1000 μm, preferably about 100 to 500 μm, in thickness.

The spreading layer may not be limited to be of only one layer, but may be composed of two or more layers laminated as described in Japanese Patent KOKAI Nos. 61-4959, 62-138756, 62-135757, 62-138758, etc.

The spreading layer may contain a nonionic, anionic, cationic or ampholytic surfactant in order to accelerate spreading of a sample. Besides, it may contain a spreading controller, such as hydrophilic polymer for the purpose of controlling spreading. Furthermore, it may contain all or a part of various reagents for accelerating the objective detecting reaction or reducing or inhibiting interfering reactions.

A suitable thickness of the spreading layer is about 50 to 1000 μm, preferably about 100 to 500 μm, more preferably about 200 to 400 μm.

A hydrophilic polymer layer, which is a typical layer of the water-permeable layer, usually contains at least a part of reagents necessary for an objective analysis, and in that case it is referred to as a reagent layer. The hydrophilic polymer layer may be composed of various known polymers of water-soluble, water-swellable and hydrophilic that have been used for conventional dry analytical elements. The hydrophilic polymer is generally a natural or synthetic hydrophilic polymer having a swelling ratio in a range of about 1.5 to 20 times, preferably about 2.5 to 15 times at water absorption at 30° C. Examples of the hydrophilic polymer are, no restrictively, gelatines, such as acid-processed gelatin and deionized gelatin, gelatin derivatives, such as phthalated gelatin and hydroxyacrylate-graft gelatin, agarose, pullulan, pullulan derivatives, polyacrylamide, polyvinyl alcohol and polyvinylpyrrolidone as described in Japanese Patent KOKAI Nos. 59-171864, 60-108753, etc. In place of the hydrophilic polymer layer, a porous polymer membrane can be used.

The hydrophilic polymer layer has thickness in a range of about 1 to 100 μm, preferably about 3 to 50 μm, and more preferably about 5 to 30 μm in dry state, and is preferably substantially transparent. It may contain all or a part of various reagents for accelerating the objective detecting reaction or reducing or inhibiting interfering reactions.

As the water-impermeable transparent support, known water-impermeable transparent supports used for conventional dry analytical elements can be used. Concrete examples include a transparent film made of polyethylene terephthalate, polycarbonate of biphenyl A, polystyrene, cellulose ester, such as cellulose diacetate, cellulose triacetate or cellulose acetate propionate, or the like having thickness in a range of about 50 μm to 1 mm, preferably about 80 μm to 300 μm. On the surface of the support, a known undercoating or adhesive layer may be provided if necessary in order to strengthen the adhesion between the support and the hydrophilic polymer layer.

The dry analytical element may have various other layers according to an objective analytical item or the sample. For example, it may comprise a detecting layer, a water-absorbing layer, a light-reflecting layer, a light-shielding layer, and the like.

This invention is characterized in that an organic solvent is supplied on the spreading layer made of polyester fabric, which is provided at the uppermost of the laminate, prior to supplying a reagent solution. The organic solvent supplied on the polyester fabric to make it hydrophilic is ampholytic, that is, it has a both nature of hydrophilic and hydrophobic. Specifically lower alcohols containing 1 to 4 carbon atoms, such as methanol, ethanol, propanol, iso-propanol or n-butanol, or ketones, such as acetone or methyl ethyl ketone are preferable, and ethanol and acetone are the most preferable.

A suitable feed rate of the organic solvent is in a range of about 30 to 90%, preferably about 50 to 70%, of the volume of the polyester fabric including its pore space. Basically the organic solvent is merely supplied uniformly on the surface of the polyester fabric, and so it is usually coated on the fabric. Coating method is also not restricted, and a spray coating is simple and easy. It is not essential to remain it in situ after the coating. The coated fabric may be dried for about 1 to 30 minutes at about 25 to 60° C.

Amount of an organic solvent coating can generally be detected using gas chromatography. The remaining organic solvent is about 0.1 to 5% of the supplied solvent.

After the surface of polyester fiber is coated with the organic solvent by supplying the organic solvent, a reagent solution is supplied on the spreading layer. Figure of the reagent solution depends on a target analyte and is usually a aqueous solution or a solution of an organic solvent, such as ethanol, acetone, etc.

There is no particular restriction of objective analytes in the present invention. Enzymes, lipids, inorganic ions, metabolic products, proteins, which are usually analyzed in clinical diagnosis, are objects of analysis using the dry analytical element. Further, ingredients from living organism, such as globulins, immune antigens, immune antibodies etc., drugs, hormones, tumor markers, DNA and RNA can also be an object of analysis, if the analytical method for each of them has been established.

The dry analytical element in accordance with this invention contains the all reagents necessary for an objective analysis. The reagent may be the same as that used for a known dry analytical element, excluding an indicator for colorimetry. Here, “the all reagents necessary for an objective analysis” mean critical reagents for an objective analysis, and other reagents may be added if necessary.

The indicator for colorimetry includes chromogens and coloring substrates which are colored or colorless. The chromogens and coloring substrates produce a determinable color change directly or indirectly which is measurable quantitatively. The chromogen may be dye, dye former or dye precursor. The indicator used in the invention is water-soluble, and has a solubility in water of 0.1% by weight or more, usually 0.5% by weight or more. Illustrative of the indicators are diazonium salts, such as dichorobenzene diazonium and benzenesulfonic acid diazonium, clolrimetry reagents, such as Alfusone and azomethine H, reduction type coloring agents, such as WST-1 and WST-3, coloring substrates, such as p-nitrophenyl derivatives, aminoaniline derivatives, 3-indole derivatives, p-nitroaniline derivatives and thio-NADH, pH indicators, such as Methyl Violet 6B, m-Cresol Purple, Congo Red, Methyl Orange, Tetrabromophenol Blue, sodium alizarinsulfonate, litmus, Bromophenol Red, Thymol Blue, Nile Blue and p-nitrophenol, metal indicators, such as Anisidine Blue, Arsenazo-III, Bathocuproine disulfonic acid disodium salt, Bathophenanthroline disulfonic acid disodium salt, Eriochrome Black T, Calcichrome, Calmagite, Carboxyarsenazo, Chlorophosphonazo-III, Chrome Azurol B, Chrome Azurol S, Dimethylsulfonazo-III, Dinitrosulfonazo-III, Methylthymol Blue, Methylxylenol Blue, Neo-Thorin, Sulfonazo-III, Xylidyl Blue-I, Xylidyl Blue-II, Nitro-PAPS, Phthalein Complexone, PDTS, Pyrocatechol Violet and Zylenol Orange, oxidation type coloring agent, such as DAB, HPPA, TMBZ.HCl, DA-67, DA-64, ABTS, MCDP, BCMA, and LLGB, couplers, such as 4-aminoantipyrine, Trinder ragents, such as ADPS, ALPS, DAPS, HADAPS, MAPS, TOPS, ADOS, ALOS, DAOS, HDAOS, MAOS, TOOS, and HALPS, and the like.

In case of supplying a surfactant or a hydrophilic polymer to the polyester fabric composing the spreading layer, it is preferable to supply it after the above mentioned coating with the organic solvent, and prior to supplying the reagent solution.

### EXAMPLES

### Example 1

An aqueous coating solution of the following composition was applied on the surface of a colorless, transparent and smooth polyethylene terephthalate (PET) film of 180 μm in thickness coated with a gelatin undercoating, and dried to form a layer having thickness of approx. 14 μm in dry state.

| | | |
|---|---|---|
| Gelatin | 14.1 | g/m² |
| Peroxidase | 12.0 | KU/m² |
| Glucose oxidase | 6.0 | KU/m² |
| Glucoamylase | 5.0 | KU/m² |
| Leuco dye | 0.5 | g/m² |
| Surfactant | 1.0 | g/m² |

Here, polyoxy(2-hydroxy)propylene nonylphenyl ether (Surfactant 10G, available from Oline Corp.) and 2-(3,5-dimethoxy-4-hydroxy phenyl)-4-(4-dimethylamino phenyl)-5-phenethyl imidazole acetate were used as the surfactant and the leuco dye, respectively.

Next, an aqueous coating solution having the following composition was applied on the film and dried to form a layer having thickness of approx. 10 μm in dry state.

| | |
|---|---|
| Gelatin | 10.2 g/m² |
| Surfactant | 0.5 g/m² |

Then, an aqueous solution having the following composition was applied on the film and dried to form a layer having thickness of approx. 8 μm in dry state.

| Hydroxypropyl cellulose | 4.7 g/m² |
|---|---|
| Carboxymethyl starch | 3.5 g/m² |
| PIPES | 0.9 g/m² |
| Mannitol | 2.3 g/m² |
| Surfactant | 1.2 g/m² |
| pH | 6.4 |

After the layer was swelled by wetting with water in the amount of approx. 60 g/m², a tricot knitted fabric formed by knitting 50 denier PET spun yarn with 36 gauge was laminated with light pressure and dried.

After the fabric was coated with ethanol in the amount of approx. 200 g/m² (=OC1 coat) and dried, it was coated with an ethanol solution (=OC2 coat) and dried to form a layer containing the following reagents and having thickness of approx. 5 μm in dry state. Thus an integral multilayer analytical element was finished.

| | | |
|---|---|---|
| Amylase-labeled anti-CRP mouse antibody | 14.0 | KU/m² |
| Anti-CRP mouse second antibody | 6.2 | mg/m² |
| Polyvinylpyrrolidone | 5.6 | g/m² |
| Surfactant | 0.2 | g/m² |

The integral multilayer analytical element was cut into chips of 12×13 mm. Then each chip was mounted in the slide holder described in JP 1982-063452 A to form a dry analytical slide(1) for analysis of CRP in accordance with the present invention.

### Example 2

A dry analytical slide(2) for analysis of CRP was prepared by the same method as the EXAMPLE 1, except that 200 g/m² of acetone was used as a coating solution of OC1 in place of ethanol.

### Example 3

A dry analytical slide(3) for analysis of CRP was prepared by the same method as the EXAMPLE 1, except that 200 g/m² of methanol was used as a coating solution of OC1 in place of ethanol.

### Comparative Example 1

A dry analytical slide(4) for analysis of CRP was prepared by the same method as the EXAMPLE 1, except that no coating of OC1 was conducted.

### Measurement Example 1

A diluent shown in the Table 1 was prepared. Then human serums containing CRP at a concentration of 1.4, 4.2 and 10.0 mg/dL, respectively, assayed by immunoturbidimetry were diluted by the diluent to 21 times to provide solutions for evaluation test. Ten μL of the diluent and each solution for evaluation test were spotted on the slide of Example 1, 2, 3 or Comparative Example 1.

TABLE 1
Composition of a Diluent

| | | |
|---|---|---|
| MES*1 | 5 | mg |
| Casein Aqueous Solution*2 | 100 | mg |
| Sodium Azide | 0.2 | mg |
| Purified Water | 1.0 | mL |

*1MES: 2-(N-morpholino) ethane sulfonic acid mono hydrate
*2Blockace (trade name) as an example

During incubation of the slide at 37° C. for 5 minutes, reflective optical density at 650 nm was measured at about every 10 seconds with Fuji Drychem 5000 (manufactured by Fuji Photo Film Co., Ltd.).

Difference of reflective optical densities (Δ ODr) of 2 minutes duration was determined using the optical densities at 3 minutes and at 5 minutes. Results are shown in Table 2.

| | Example | | | Comparative |
|---|---|---|---|---|
| | 1 | 2 | 3 | Example 1 |
| Diluent | 0.428 | 0.407 | 0.424 | 0.353 |
| CRP 1.4 mg/dL | 0.383 | 0.349 | 0.362 | 0.291 |
| CRP 4.2 mg/dL | 0.317 | 0.287 | 0.299 | 0.236 |
| CRP 10.0 mg/dL | 0.236 | 0.222 | 0.226 | 0.187 |
| OD-range* | 0.192 | 0.185 | 0.198 | 0.166 |

*OD-range: Δ ODr(diluent) - Δ ODr(10 mg/dL)

As clearly seen from the Table 2, the OD-range, which is the measure of gradient of a calibration curve, of Examples 1, 2, and 3 is better by far compared with that of Comparative Example 1.

### Measurement Example 2

The solution for evaluation test as to the CRP concentration of 4.2 mg/dL was prepared in the same way as MEASURMENT Example 1. Ten μL of the solution was spotted to ten slides of Example 1, 2, 3 and Comparative Example 1.

Then difference of reflective optical densities (Δ ODr) of 2 minutes duration for each slide was determined in the same way as MEASURMENT Example 1.

Each Δ ODr was converted to CRP concentration by use of a calibration curve provided as an approximated cubic formula derived using the measured optical density and the CRP concentration of Measurement Example 1. Then coefficient for variation (CV; n=10) of each analytical element was determined. Results are represented in the Table 3.

TABLE 3

| | Example | | | Comparative |
|---|---|---|---|---|
| | 1 | 2 | 3 | Example 1 |
| 1 | 4.1 | 4.3 | 4.4 | 4.0 |
| 2 | 4.3 | 4.2 | 4.3 | 3.9 |
| 3 | 4.2 | 4.1 | 4.0 | 3.9 |
| 4 | 4.1 | 4.1 | 4.5 | 3.9 |
| 5 | 4.2 | 4.2 | 4.2 | 3.9 |
| 6 | 4.3 | 4.4 | 4.1 | 3.3 |
| 7 | 4.4 | 4.1 | 4.3 | 3.8 |
| 8 | 4.5 | 4.0 | 4.2 | 3.9 |
| 9 | 4.1 | 4.5 | 4.2 | 5.0 |
| 10 | 4.4 | 4.4 | 4.4 | 4.7 |
| Average Value | 4.3 | 4.2 | 4.3 | 4.0 |
| SD (mg/dL) | 0.14 | 0.16 | 0.15 | 0.48 |
| CV (%) | 3.4 | 3.9 | 3.5 | 11.9 |

As shown in Table 3, the coefficient of variation, which is the scale of fluctuation in measurement, of the slide of Example 1, 2 or 3 is small compared with that of the slide of Comparative Example 1. Thus, the dry analytical element in accordance with the invention has a superior performance.

The coating treatment with an organic solvent in accordance with the invention permits a reagent to penetrate easily into bottom of a polyester fabric, and achieves uniform inclusion of the reagent in the fabric. In result, not only coefficient of variation can be improved by virtue of decrease of coloring unevenness, but also coloring strength can be enhanced.

1. A dry analytical element comprising a water-impermeable transparent support, at least one water-permeable layer, and a spreading layer which is composed of polyester and has a function of spreading liquid uniformly, laminated in this order, characterized in that surface of fiber constituting said spreading layer is coated with an organic solvent.

2. Manufacturing method of a dry analytical element, characterized in that said method comprises a step of supplying an organic solvent on a spreading layer which is composed of polyester, has a function of spreading liquid uniformly, and is laminated on a water-permeable layer including at least one layer laminated on a water-impermeable transparent support, and a subsequent step of supplying a reagent solution on said spreading layer.
